(19) United States
(12) Patent Application Publication
(10) Pub. No.: US 2017/0064184 A1
(43) Pub. Date: Mar. 2, 2017

(54) FOCUSING SYSTEM AND METHOD

(71) Applicant: LUSTROUS ELECTRO-OPTIC CO.,LTD., NEW TAIPEI CITY (TW)

(72) Inventor: CHIH-WEI TSAI, HSINCHU CITY (TW)

(21) Appl. No.: 14/833,854

(22) Filed: Aug. 24, 2015

(51) Int. Cl. H04N 5/232; G02B 7/28; G02B 7/36; G02B 3/14; G02B 13/00

(52) U.S. Cl. CPC H04N 5/23212; H04N 5/23232; H04N 5/23296; G02B 3/14; G02B 13/0055; G02B 7/36; G02B 7/285

(57) ABSTRACT

A focusing system and focusing method are provided. The focusing method includes the steps of: adjusting a focal length of a liquid lens unit of an auxiliary lens module to scan a focus distance of the auxiliary lens module, wherein the auxiliary lens module includes a plurality of focus sections, wherein the focus sections are focally scanned by the liquid lens unit; analyzing a plurality of image information respectively corresponding to the focus sections to determine a preferred focus section in which a sharpest image is captured; transmitting an information of the preferred focus section in which the sharpest image is captured to a main lens module; and adjusting a focus of the main lens module according to the information of the preferred focus section so that the main lens module is automatically focused within the preferred focus section.

### BACKGROUND OF THE INVENTION

1. Field of the Invention

The instant disclosure relates to a focusing system and a focusing method; in particular, to a focusing system and a focusing method for instantly focusing upon an object.

2. Description of Related Art

As technology develops, the current portable devices, such as smart phone, tablet, and so on, have more and more functions. By using portable devices, the user not only can communicate with others, but also can take a picture.

Typically portable device has only one lens using a passive autofocus technique. In addition, the trend of development is that the number of pixels in one image captured by the portable device increases more and more. Generally speaking, the frame rate of a portable device, which can display an image having 8 to 10 million pixels, even to 20 million pixels, ranges between about 25 to 30 FPS. However, the portable device has to process much data because of the large number of pixels such that the access speed of data is decreased. As such, the portable device cannot rapidly capture the image. Furthermore, the portable device drives the lens to focus by using a voice coil actuator or voice coil motor, which may lead to vibration during capturing the image.

Accordingly, providing a technique to rapidly focus to address the above issue is important for one of ordinary skilled in the art.

### SUMMARY OF THE INVENTION

The objective of the instant disclosure is to provide a focusing system and a focusing method to immediately focus and capture an image.

In order to achieve the aforementioned objectives, according to an embodiment of the instant disclosure, a focusing method is provided. The focusing method includes the following steps: adjusting a focal length of a liquid lens unit of an auxiliary lens module to scan a focus distance of the auxiliary lens module, wherein the liquid lens unit of the auxiliary lens module is set to have a plurality of focus sections, wherein the focus sections are focally scanned by the liquid lens unit; analyzing a plurality of image information respectively corresponding to the focus sections to determine a preferred focus section in which a sharpest image is captured; transmitting an information of the preferred focus section in which the sharpest image is captured to a main lens module; and adjusting a focus of the main lens module according to the information of the preferred focus section so that the main lens module is automatically focused within the preferred focus section.

The instant disclosure also provides a focusing system. The focusing system includes an auxiliary lens module, a control module, and a main lens module. The auxiliary lens module includes an image capture unit and a liquid lens unit. The liquid lens unit is set to have a plurality of focus sections. During a process of adjusting the focal length of the liquid lens unit, the image capture unit is used to capture a plurality of images respectively generated in the corresponding focus sections. The control module is electrically connected to the auxiliary lens module to analyze the images respectively generated in the corresponding focus sections and determine a preferred focus section in which the sharpest image is captured. The main lens module is electrically connected to the control module, and the main lens module is automatically focused on an object according to information of the preferred focus section.

The instant disclosure provides the following improvements. In the focusing system and the focusing method in accordance with the embodiments of the instant disclosure, the focus sections can be scanned firstly by the image capture unit of the auxiliary lens module through the step of adjusting the focal length of the liquid lens unit, thereafter, the control module analyzes the images captured by the image capture unit to rapidly determine the preferred focus section in which the sharpest image is captured. As such, the focus of the main lens module can be directly adjusted to be located in the preferred focus section to perform an autofocus process. Accordingly, the function of rapidly focusing the main lens module can be achieved.

That is, in the focusing system and the focusing method in accordance with the embodiment of the instant disclosure, at least two lens modules are provided. One of the lens modules is capable of capturing a low resolution image, and the other of the lens modules is capable of capturing a high resolution image. The lens module for capturing the low resolution image includes the liquid lens unit to determine the preferred focus section rapidly. The focal length of the lens module for capturing high resolution image can be directly adjusted to fall within the preferred focus section. Thereafter, the lens module which is capable of capturing a high resolution image can be automatically focused only in the preferred focus section. That is, because the auxiliary lens module can roughly estimate a range for focusing, the main lens module does not need to scan all of the focus sections to determine the best position of the focus, which can accelerate focus speed.

In order to further understand the instant disclosure, the following embodiments and illustrations are provided. However, the detailed description and drawings are merely illustrative of the disclosure, rather than limiting the scope being defined by the appended claims and equivalents thereof

### BRIEF DESCRIPTION OF THE DRAWINGS

FIG. 1 is a block diagram of a focusing system in accordance with a first embodiment of the instant disclosure;

FIG. 2 is a block diagram of a focusing system in accordance with a second embodiment of the instant disclosure; and

FIG. 3 is a schematic diagram illustrating focal-plane scanning principle of the method for capturing images in accordance with an embodiment of the instant disclosure.

### DETAILED DESCRIPTION OF THE PREFERRED EMBODIMENTS

In the following description, numerous specific details of a focusing system and focusing method according to the embodiments of the instant disclosure are set forth in order to provide a thorough understanding of one or more aspects and/or features described herein. It will be apparent, to one skilled in the art, to readily understand the advantages and the effectiveness of the instant disclosure. Furthermore, the instant disclosure can also be implemented or applied by various other specific examples. The details in the following descriptions can also be modified or changed based on different perspectives and applications without departing from the spirit of the instant disclosure. In addition, the drawings as referred to throughout the description of the instant disclosure are for illustrative purpose only, but not drawn according to actual scale, i.e., the actual scale of the related structure is not illustrated. The relative techniques of the instant disclosure will be set forth through the following embodiments, but are not intended to limit the scope of the instant disclosure.

### First Embodiment

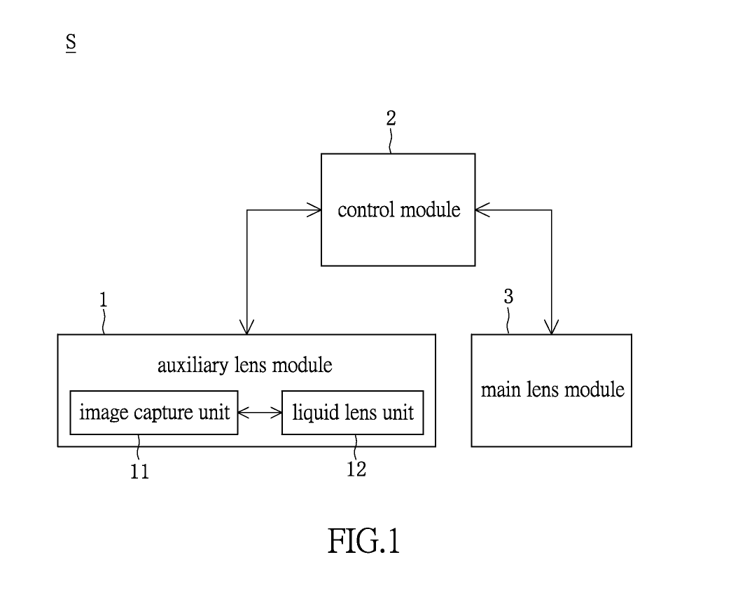

Please refer to FIG. 1. FIG. 1 is a block diagram of a focusing system in accordance with a first embodiment of the instant disclosure. In the first embodiment of the instant disclosure, a focusing system S is provided. The focusing system S includes an auxiliary lens module 1, a control module 2, and a main lens module 3. For example, the focusing system S provided in the instant disclosure can be implemented in electronic devices, such as a smart phone, a tablet and so on.

As shown in FIG. 1, the auxiliary lens module can include an image capture unit 11 and a liquid lens unit 12. The control module can be electrically connected to the auxiliary lens module 1 and the main lens module 3 so as to control the auxiliary lens module 1 and the main lens module 3. In addition, the liquid lens unit 12 is set to have a plurality of focus sections. It is worth noting that when different bias voltage is applied to the liquid lens unit 12, the curvature of liquid lens unit 12 can be varied so that a focal length of the liquid lens unit 12 can be adjusted. The focus sections use different focus distance ranges, in which the image capture unit 11 can capture more definite images when the liquid lens unit 12 respectively has different curvatures. For example, the focus sections can respectively range from 5 m to 10 m, from 10 m to 20 m, from 20 m to 50 m, from 50 m to 100 m, from 100 m to infinity, but the example does not intend to limit the instant disclosure. The focus sections can be defined dependent on the design of the auxiliary lens module 1. Accordingly, when the control module 2 receives a start signal, which may be inputted by a user to start up the image-capture function, the control module 2 can control the image capture unit 11 to capture a plurality of continuous images at different focus sections during the processes of adjusting the focal length of the liquid lens unit 12. That is, the image capture unit 11 subsequently captures the plurality of images at different focus distances.

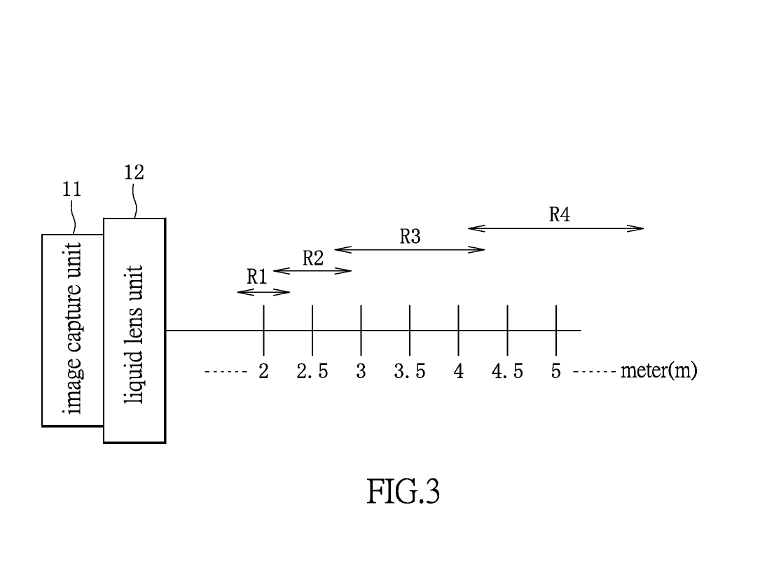

Please refer to FIG. 3. FIG. 3 is a schematic diagram illustrating focal-plane scanning principle of the method for capturing images in accordance with an embodiment of the instant disclosure. The vertical axis represents the focal plane of the focusing system, while the horizontal axis represents the depth of field at this focal plane. Typically, the closer a focal plane is to the image capture unit 11, the shallower the depth of field. The liquid lens unit 12 of the instant disclosure applies focal-plane scanning, which includes capturing a plurality of images from far to near or from near to far scanning range to obtain images at different focal planes. With the appropriate focal-plane scanning by the liquid lens unit 12, the subsequently captured images at different focal planes cover the preferred set distance for image capturing. For example, as shown in FIG. 3, a depth of field at a focus distance (distance between focal plane and auxiliary lens module) of 2 meters is defined as depth of field R1, a second depth of field at a focal length of 2.5 meters is defined as depth of field R2, a third depth of field at a focus distance of 3.5 meters is defined as depth of field R3, and a fourth depth of field at a focus distance of 5 meters is defined as depth of field R4. The focal length of the liquid lens unit 12 can be adjusted to scan from near to far or far to near. Due to the short focal-plane adjustment time (at <10 ms class), image scanning can be swiftly accomplished.

Moreover, the auxiliary lens module 1 having a pixel resolution smaller than five-million pixel resolution can be selected to accelerate the focus speed. In addition, the frame rate of the auxiliary lens module 1 can be greater than 60 FPS. Preferably, the auxiliary lens module 1 having lower pixel resolution, such as a compact camera module (CCM) having a pixel resolution smaller than two-million pixel resolution, can be chosen. The auxiliary lens module 1 with lower pixel resolution has a higher frame rate, e.g., as high as 90 to even 120 frames per second. As such, the image information can be processed more rapidly. That is, the fewer the pixel number the provided auxiliary lens module 1 has, the higher the frame rate of the auxiliary lens module 1. Meanwhile, the amount of computation and analysis of the control module 2 can be decreased to improve the computing efficiency.

During the process of applying focal-plane scanning by the liquid lens unit 12 of the auxiliary lens module 1, the image capture unit 11 can continuously capture a plurality of images in each of the focus sections. Specifically, the image capture unit 11 can subsequently capture a plurality of images with different focus distances, and transmit the continuously captured images to the control module 2. For example, the image capture unit 11 can capture about ten to forty images generated in different focus sections or at different focal planes respectively corresponding to different focus distances. Notably, the more the captured images, the more time it takes. The user can select the amount of the captured images. Preferably, the image capture unit 11 can capture ten to twenty images in different focus sections or at different focal planes respectively corresponding to different focus distances.

The control module 2 can analyze the image information which is relative to the captured images and transmitted from the auxiliary lens module 1, and determine a preferred focus section in which the sharpest image is captured. Accordingly, the information of the preferred focus section in which the sharpest image is captured can be obtained. Specifically, the control module 2 can calculate a contrast and a sharpness of each of the captured images through a resolution algorithm, such as a modulation transfer method (MTF), by using the principle of the resolution algorithm. Specifically, when the image capture unit 11 captures the images in different focus sections, the more sharp an edge of an object in the captured images, the more clear the captured image, i.e. the pixel gray scale difference value at the edge of the object is larger. According to these characteristics, the control module 2 can analyze the images captured by the image capture unit 11 at different focus sections to obtain a sharpness data information which may be a standard condition for determining whether the captured images are sharp or not. Additionally, some of the indistinctness in the captured images may be caused by the condition that the intensity of the high frequency signals is lower than that of the low frequency signals. The problem can be improved by using a high-pass filter to filter a specific frequency band so that the high-frequency signals in each of the captured images can be obtained to be determined. Furthermore, in the instant embodiment, the control module 2 can be, but is not limited to, a microcontroller unit (MCU), or a processor, such as a central processing unit, in a portable electronic device.

The main lens module 3 can be automatically focused according to the information of the preferred focus section in which the sharpest image is captured so as to adjust a focus position of the main lens module 3. Specifically, the main lens module 3 can be a camera module implemented in a portable electronic device mainly for taking the pictures. The main lens module 3 can include a lens unit (not shown), and the main lens module 3 can directly adjust a focus of the lens unit to locate in the preferred focus section according to the information of the preferred focus section or the focus distance transmitted by the control module 2. As such, it is not necessary to take much time for the main lens module 3 to focus from infinity to the nearest distance.

The focusing system S of the embodiments of the instant disclosure includes at least two lens modules, i.e., the main lens module 3 and the auxiliary lens module 1. Notably, the main lens module 3 and the auxiliary lens module 1 are disposed immediate to each other for capturing a substantially similar image.

It is worth noting that when the focusing system S is implemented in a portable electronic device, the auxiliary lens module 1 can serve as a fingerprint reader to identify the user's fingerprint. Specifically, while the focal length of the liquid lens unit 12 is adjusted to scan the fingerprint, the image capture unit 11 can capture a plurality of the fingerprint images so that the finger recognition can be completed.

### Second Embodiment

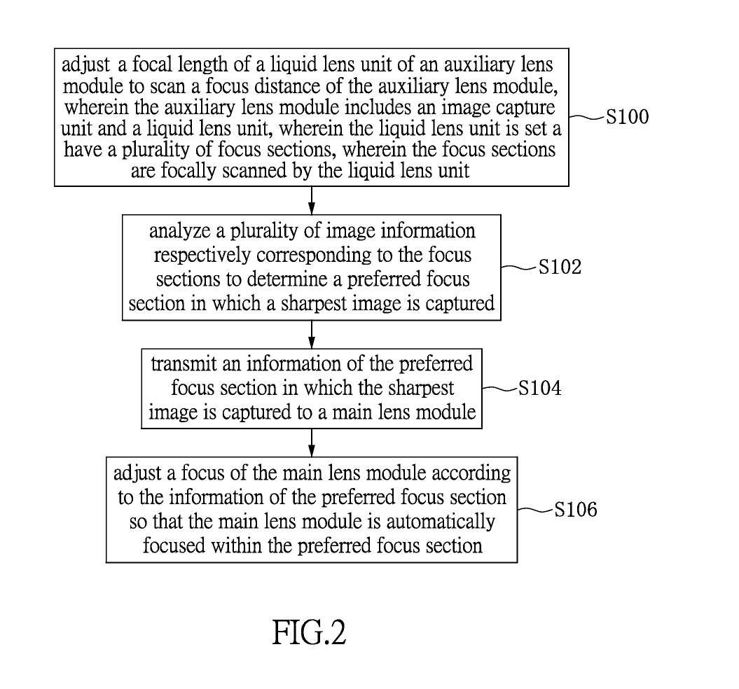

Please refer to FIG. 2 and FIG. 1. FIG. 2 is a block diagram of a focusing system in accordance with a second embodiment of the instant disclosure. The focusing method is provided in the second embodiment of the instant disclosure to focus rapidly. In step S100, the focal length of the liquid lens unit 12 of the auxiliary lens module 1 is adjusted to scan a focus distance of the auxiliary lens module 1. The auxiliary lens module 1 is set to have a plurality of focus sections, and the liquid lens unit 12 is actuated to scan the focus distance. For example, under a control of the control module 2, the focal length of the liquid lens unit 12 can be adjusted from far to near or near to far distance to scan the focus distance. In addition, in another embodiment, the focal length of the liquid lens unit 12 can be adjusted by the process of adjusting the focal length a single time, the process of continuously adjusting the focal length, the process of adjusting the focal length within a predetermined range a single time, or a process of continuously adjusting the focal length within a predetermined range. Subsequently, because the auxiliary lens module 1 has been set to include the plurality of focus sections, a focal-plane scanning by the liquid lens unit 12 is performed to each of focus sections.

As mentioned previously, the image capture unit 11 of the auxiliary lens module 1 can be used to capture a series of images corresponding to different focus sections during the process of the focal-plane scanning by the liquid lens unit 12.

For example, the image capture unit 11 can capture about ten to forty continuous images which are respectively generated at different focus planes corresponding to different focus distances. Preferably, the image capture unit 11 can capture ten to twenty images respectively generated in the corresponding focus sections or at different focal planes corresponding to different focus distances. Moreover, in the embodiment provided in the instant disclosure, the auxiliary lens module 1 having a pixel resolution smaller than five-million pixel resolution and the frame rate greater than 60 FPS can be selected. Preferably, the auxiliary lens module 1 having lower pixel resolution, such as smaller than two-million pixel resolution, can be chosen to have greater frame rate, which can be greater than 90 FPS or even 120 FPS. As such, the image information can be accessed more rapidly.

Subsequently, in step S102, the image information respectively corresponding to the focus sections is analyzed to determine a preferred focus section in which the sharpest image has been captured. For example, the preferred focus section having the sharpest image can correspond to an image captured at a correct focus or at the best the focal plane. In addition, the process of determining whether each of the captured images is sharp, or whether each of the images is captured at a correct focus can be performed by the control module 2 according to the sharpness of each of the images captured in different focus sections to select the sharpest image. Notably, the sharpest image generated in the preferred focus section can be determined according to the contrast or the sharpness of the captured images or according to the pixel gray scale difference value or the gray gradient at the edge of the object. Moreover, the control module 2 can analyze and calculate the distance information of the preferred focus section according to the corresponding focal length of the liquid lens unit 12 and the contrast and the sharpness of the captured images, and store the distance information of the preferred focus section. In addition, the other sharpness algorithm also can be applied to determine the distance information of the current focus sections.

In the step S100, the focal length of the liquid lens unit 12 of the auxiliary lens module 1 is adjusted to scan the focus distance, in which the auxiliary lens module 1 is set to have a plurality of focus sections, and the focal plane of the liquid lens unit 12 is adjusted to be located in each of the focus sections to scan the focus distance, and in step S102, the image information respectively corresponding to the focus sections is analyzed to determine a preferred focus section in which the sharpest image is captured. Notably, the detailed process in step S100 and step S102 can include that when the scanning process of one of the focus sections performed by the auxiliary lens module 1 is completed, the control module 2 receives the image information corresponding to the scanned focus section and starts to analyze it. As such, after the focal-plane scanning of the liquid lens unit 12 for all of the focus sections is completed, the analyzing process of image information corresponding to the focus sections performed by the control module 2 also can be done. Subsequently, the control module 2 can determine the preferred section in which the sharpest image is captured and the distance information of the preferred focus section according to the image information.

In step S104, the information of the preferred focus section in which the sharpest image is captured is transmitted to a main lens module 3. For example, the control module 2 obtains the distance information of the preferred focus section and transmits focus distance information to the main lens module 3.

Accordingly, in step S106, the main lens module 3 is automatically focused within the preferred focus section according to the focus distance information of the preferred focus section in which the sharpest image is captured. In other words, after receiving the focus distance information from the control module 2, the main lens module 3 can directly adjust the focus of the main lens module 3 to be located in the preferred focus section according to the focus distance information, and automatically focus in the preferred focus section.

The instant disclosure provides the following improvements. In the focusing system S and the focusing method in accordance with the embodiments of the instant disclosure, by the process of focal-plane scanning of the liquid lens unit 12 of the auxiliary lens module 1, and by the process of computation of the control module 2, the focus distance information of the preferred focus section in which the sharpest image is captured can be obtained rapidly. Accordingly, the main lens module 3 can adjust the focus distance of the main lens module 3 according to the focus distance information so that the focal plane of the main lens module 3 is located within the preferred focus section, which can improve the focus speed of the main lens module 3. That is, in the focusing system and the focusing method in accordance with an embodiment of the instant disclosure, at least two lens modules are provided. One of the lens modules is capable of capturing low resolution image, and the other of the lens modules is capable of capturing a high resolution image. The lens module for capturing the low resolution image, i.e., the auxiliary lens module, includes the liquid lens unit to improve the focus speed. The lens module for capturing high resolution image, i.e., the main lens module, can perform the autofocus process after receiving the focus distance of the preferred focus section. That is, the main lens module can directly adjust the focal plane to fall within the preferred focus section to perform the autofocus process.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A focusing method, comprising the steps of:
adjusting a focal length of a liquid lens unit of an auxiliary lens module to scan a focus distance of the auxiliary lens module, wherein the liquid lens unit is set a have a plurality of focus sections, wherein the focus sections are focally scanned by the liquid lens unit;
analyzing a plurality of image information respectively corresponding to the focus sections to determine a preferred focus section in which a sharpest image is captured;
transmitting an information of the preferred focus section in which the sharpest image is captured to a main lens module; and
adjusting a focus of the main lens module according to the information of the preferred focus section so that the main lens module is automatically focused within the preferred focus section.

2. The focusing method as recited in claim 1, wherein the information of the preferred focus section is obtained according to a contrast or a sharpness of each of the images respectively captured in different focus sections.

3. The focusing method as recited in claim 1, wherein the step of adjusting the focal length of the liquid lens unit is a process of adjusting the focal length at a single time, a process of continuously adjusting the focal length, a process of adjusting the focal length within a predetermined range at a single time, or a process of continuously adjusting the focal length within a predetermined range.

4. A focusing system, comprising:
an auxiliary lens module including an image capture unit and a liquid lens unit, wherein the liquid lens unit is set to have a plurality of focus sections, and the image capture unit is used to capture a plurality of images respectively generated in the corresponding focus sections during a process of adjusting a focal length of the liquid lens unit;
a control module electrically connected to the auxiliary lens module to analyze the images respectively generated in the corresponding focus sections and determine a preferred focus section in which the sharpest image is captured; and
a main lens module electrically connected to the control module, wherein the main lens module is automatically focused on an object according to an information of the preferred focus section.

5. The focusing system as recited in claim 4, wherein the auxiliary lens module has a pixel resolution smaller than two-million pixel resolution and a frame rate larger than 60 FPS.

6. The focusing system as recited in claim 5, wherein the image capture unit captures ten to twenty images respectively generated in the corresponding focus sections during the process of adjusting the focal length of the liquid lens unit.
